(19) United States
(12) Patent Application Publication
(10) Pub. No.: US 2004/0215703 A1
(43) Pub. Date: Oct. 28, 2004

(54) System supporting concurrent operation of multiple executable application operation sessions

(76) Inventors: Xiping Song, Cranbury, NJ (US); John D. Haley, Honey Brook, PA (US); Keith Kaehn, Phoenixville, PA (US)

Correspondence Address: Alexander J. Burke, 170 Wood Avenue South, 5th Floor, Intellectual Property Department, Iselin, NJ, 08830, US

(21) Appl. No.: 10/771,946

(22) Filed: Feb. 4, 2004

Related U.S. Application Data
(60) Provisional application No. 60/448,443, filed on Feb. 18, 2003.

(51) Int. Cl. G06F 15/16

(52) U.S. Cl. 709/201

(57) ABSTRACT

According to one aspect of the present invention, a system, employing an application for supporting concurrent operation of multiple user initiated operation sessions, includes a communication processor and a processor. The communication processor communicates a session initiation request to a managing application to initiate generation of a session identifier particular to a user-initiated session. The communication processor receives from the managing application data representing a response address link identifying an address of a web page supporting the particular user initiated session. The data representing the response address link incorporates an identifier for identifying a particular server supporting the particular user initiated session. The processor parses the received data representing the response address link to extract and store the server identifier for use in directing communications associated with the particular user initiated session to the particular server.

### CROSS-REFERENCE TO RELATED APPLICATIONS

The present application is a non-provisional application of provisional application having Ser. No. 60/448,443, filed by Xiping Song et al. on Feb. 18, 2003.

### FIELD OF THE INVENTION

The present invention generally relates to computer information systems. More particularly, the present invention relates to a system supporting concurrent operation of multiple executable application operation sessions.

### BACKGROUND OF THE INVENTION

The growth of network services, for example Internet services or intranet services, has made significant demands on the availability and performance of Internet and intranet sites and the computer servers supporting the sites. Growth in the demands is related to increasing numbers of users, increasing complexity of applications, and increasing demands for better service. To address performance and reliability issues associated with the growth in demand, the sites use one or more switches to assign requests from multiple users to multiple servers.

Users access the network services using a client having a browser. The browser provides a user interface between the user and the client, and the sites. Typically, a user is permitted to run a single business session (e.g., a shopping cart) on a single browser. If the user wants to run a new business session (e.g., a new shopping cart), the user typically needs to end the current business session on the browser and then start a new business session on the browser. The user may also run the new business session by opening a new browser.

Some software applications support running multiple, concurrent, business sessions on a single browser. A challenge in implementing these applications is determining how to assign each business session to one of the multiple servers. The server holds state information (otherwise referred to as “stateful information”) related to user requests for one or more business sessions on behalf of the client. Executing stateful business sessions on more than one server can cause the servers to fail to retrieve the correct information, since the desired information might reside on a different server. For example, when running a shopping cart business session on two servers, each server may have part of the orders in the shopping cart.

Prior systems implemented server assignments at different levels by using different methods, such as those based on an internet protocol (IP) address, a session cookie, and a universal resource locator (URL) session identification (ID).

The IP address method provides assignment of a server at the client level. A content switch balances the load depending on different IP addresses (and/or port number) of a client. When each client has an independent, different IP address, the load can be balanced among the servers and the business sessions from the same client can be assigned to the same server.

The session cookie method provides assignment of a server at the browser or user level. The session cookie is an identifier passed together with a client request to a server to identify a session and a corresponding request. With the session cookie, the server can know which session the request is from. The content switch detects the session cookie from a user's browser and assigns (i.e., “sticks”) the requests from the same Hyper Text Transfer Protocol (HTTP) session to a server. If the cookie timeout is not set, the session cookie will be available until a user closes a browser. Thus, the requests from the newly opened browser can be re-distributed among the servers. If the cookie timeout is set, when this user session ends, the HTTP requests from the browser are re-distributed.

The URL session ID method provides assignment of a server by using a business session ID as a parameter of the URL. This method requires having a dedicated server that generates the business session IDs and assigns a business session ID for each new business session. Hence, a client requests a new business session ID before starting each new business session, which generates additional communication between the client and the server. The client who has requested to start the business process receives the business session ID, and includes the business session ID as a parameter in the URLs that start the business session or make subsequent requests. The content switch assigns these request to a server based upon the evaluation of the business session ID by a sorting method in the content switch.

Load balancing permits the network service load to be distributed dynamically and efficiently to each of multiple network service servers according to its status. Since loads are balanced based upon information from the clients or users, the load may not be evenly distributed.

Draining a server involves gradually clearing the processing of the users' requests on the server for service maintenance. Terminating the processing of the users requests on the server interrupts user applications. Draining a server in a user-based, load-balancing environment can cause existing business sessions to be interrupted. Interrupted users may have to login again and re-start business sessions, which can lead to the loss of the data which has been previously entered.

In recent years, as network services have increased with the rapid spread of Internet/Intranet, the demand has increased for more efficient utilization of the client server system and increasing the stability of services of servers. In particular, there is a demand for an environment, which permits centralized access to a WWW (World Wide Web) server to be circumvented and failures to be hidden. For this reason, some systems provide two or more servers (or nodes) to perform one service (for example, ftp (file transfer protocol), HTTP (Hyper Text Transfer Protocol), telnet, or the like).

In order to implement services with stability, it is required to distribute services to each server suitably. On the other hand, the network services have become increasingly diversified, complicated, and advanced, and the frequency at which changes are made to the configuration of a group of servers and the service distribution method has increased. The demand also has increased for circumventing stops of some services due to some servers going down unexpectedly. Existing techniques of distributing services to multiple servers include Round-robin Domain Name Server (DNS), load distribution hardware, and an agent.

In the Round-robin DNS service, an entry table is set up in which multiple server IP (Internet Protocol) addresses are mapped to one domain name. When a client makes an inquiry about a server IP address, servers are allocated to the client on a round robin basis according the entry table. The IP addresses of the allocated servers are presented to the clientto distribute services to multiple servers. However, in the Round-robin DNS service, services are distributed to servers equally or at simple rates and each server has to perform services allocated to itself irrespective of its capabilities and dynamic load conditions. This produces a difference in load condition between each server, resulting in reduced efficiency of the whole system. Further, in the event that a server has gone down and the configuration of the server group has to be modified accordingly, it is required to manually make such a change to the server group configuration to delete a server that went down from the entry table. This change is made each time a server goes down. It is therefore difficult to cope with such a situation immediately. As a result, the whole system will have to be stopped temporarily.

Using load distribution hardware, a hardware device is placed between a server group and a network to relay communications between clients and servers. Load measuring communications are made between the hardware device and each server. Packets to be relayed are monitored to measure the number of connections to each server and its response time, thereby detecting the load condition of each server and distributing services to the servers accordingly. However, the hardware has high implementation costs. The employment of this system is limited because the hardware is not incorporated into each server. In addition, since communications for load measurement are needed between each server, extra load, which is different from original communications, is imposed on each server, which further increases traffic and may cause servers to go down. Furthermore, since the load is measured on a packet-by-packet basis, the servers may be switched even in mid-service causing errors to occur.

The agent resides on each server in a server group measures a load on its central processing unit (CPU) and its disk utilization to see its load condition. The load distribution system is notified of the load condition of each server and distributes services to the servers accordingly. However, since an agent function resides on each server, the server has to be modified at the time the agent is installed. The agent is also compatible with the server's operating system (OS). The load measurement is made for each server, resulting in an increase in the load on the server. Since the load is measured on a packet-by-packet basis, the servers may be switched even in mid-service causing errors to occur, as with the hardware device.

Accordingly, there is a need for a system supporting concurrent operation of multiple executable application operation sessions that overcomes these and other disadvantages of the prior systems.

### SUMMARY OF THE INVENTION

According to one aspect of the present invention, a system, employing an application for supporting concurrent operation of multiple user initiated operation sessions, includes a communication processor and a processor. The communication processor communicates a session initiation request to a managing application to initiate generation of a session identifier particular to a user-initiated session. The communication processor receives from the managing application data representing a response address link identifying an address of a web page supporting the particular user initiated session. The data representing the response address link incorporates an identifier for identifying a particular server supporting the particular user initiated session. The processor parses the received data representing the response address link to extract and store the server identifier for use in directing communications associated with the particular user initiated session to the particular server.

### BRIEF DESCRIPTION OF THE DRAWINGS

FIG. 1 illustrates a communication system, in accordance with a preferred embodiment of the present invention.

FIG. 2 illustrates business session to server assignments for the communication system, as shown in FIG. 1, in accordance with the preferred embodiment of the present invention.

FIG. 3 illustrates a communication system method for the communication system, as shown in FIG. 1, in accordance with a preferred embodiment of the present invention.

FIG. 4 illustrates a detailed client method for the communication system method, as shown in FIG. 3, in accordance with the preferred embodiment of the present invention.

FIG. 5 illustrates a detailed content switch method for the communication system method, as shown in FIG. 3, in accordance with the preferred embodiment of the present invention.

FIG. 6 illustrates a detailed server(s) method for the communication system method, as shown in FIG. 3, in accordance with the preferred embodiment of the present invention.

FIG. 7 illustrates a user interface for a patient check-in business session for the client, as shown in FIGS. 1 and 2, and for the detailed client method, as shown in FIG. 4, in accordance with the preferred embodiment of the present invention.

FIG. 8 illustrates a user interface for a patient check-out business session for the client, as shown in FIGS. 1 and 2, and for the detailed client method, as shown in FIG. 4, in accordance with the preferred embodiment of the present invention.

### DETAILED DESCRIPTION OF THE PREFERRED EMBODIMENT

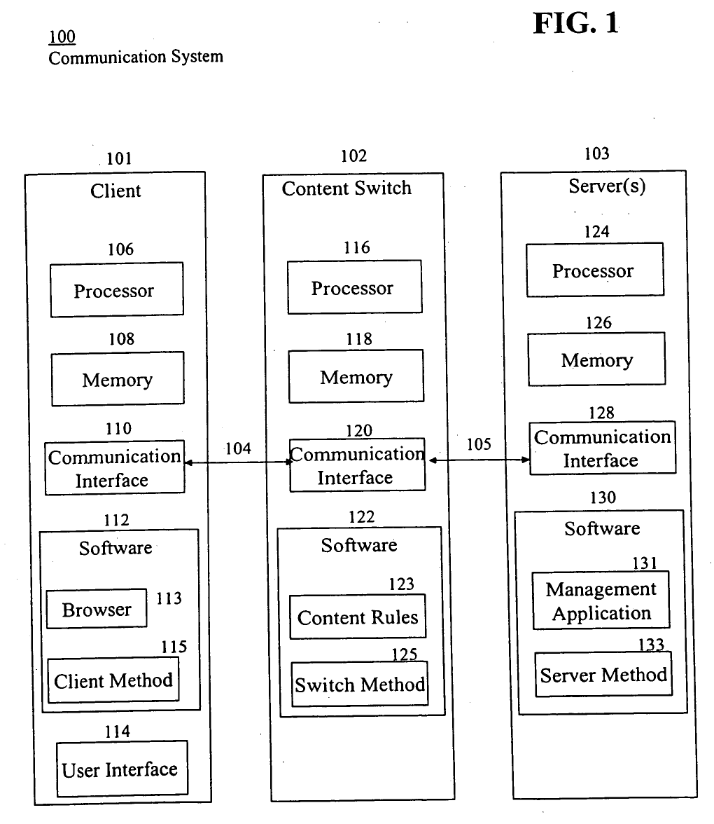

FIG. 1 illustrates a communication system 100 (herein called the “system”), in accordance with a preferred embodiment of the present invention. The system 100 generally includes a client 101, a content switch 102 (herein called the “switch”), one or more servers 103, a first communication network 104, and a second communication network 105.

Preferably, the system 100 is intended for use by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. In the preferred embodiment of the present invention, the healthcare provider is a hospital. Examples of the people being serviced by the healthcare provider include, without limitation, a patient, a resident, and a client.

The client 101 includes a processor 106, a memory 108, a communication interface 110, software 112, and a user interface 114. The software 112 further includes a browser 113 and a client method 115. The client 101 is preferably implemented as a personal computer. The personal computer may be fixed or mobile and may be implemented in a variety of forms including, without limitation, a desktop computer, a laptop computer, a personal digital assistant (PDA), and a cellular telephone. Each of the referenced elements, as well as other known elements not shown, in the client 101 are interconnected in a manner well known to those skilled in the art of clients.

Preferably, the user interface 114 in the client 101 generally includes an input device that permits a user to input information into the client 101 and an output device that permits a user to receive information from the client 101. Preferably, the input device is a keyboard, but also may be a touch screen, or a microphone with a voice recognition program, for example. Preferably, the output device is a display, but also may be a speaker, for example. The output device provides information to the user responsive to the input device receiving information from the user or responsive to other activity by the client 101. For example, the display presents information responsive to the user entering information in the client 101 via the keyboard.

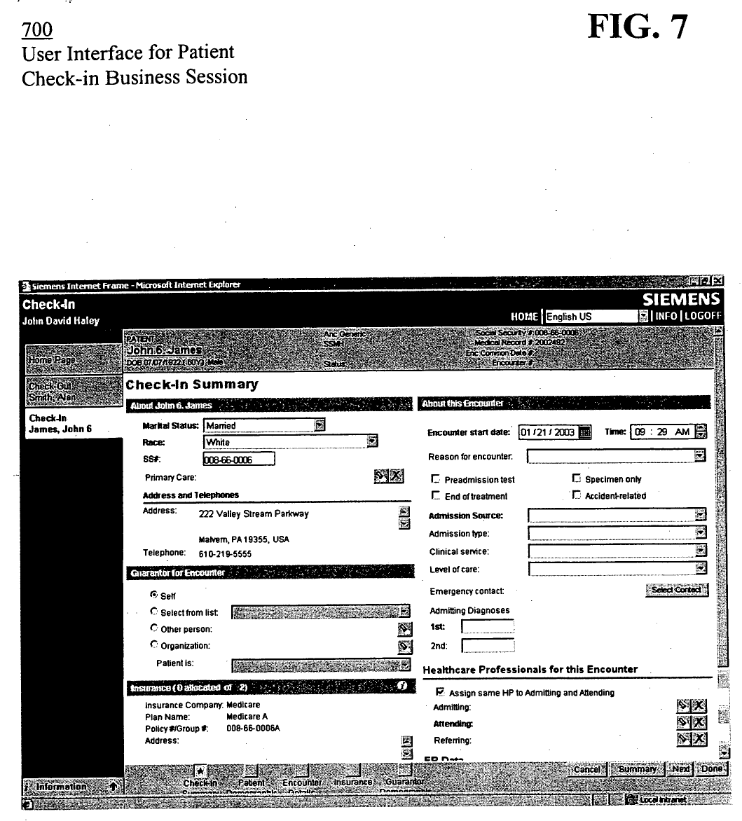

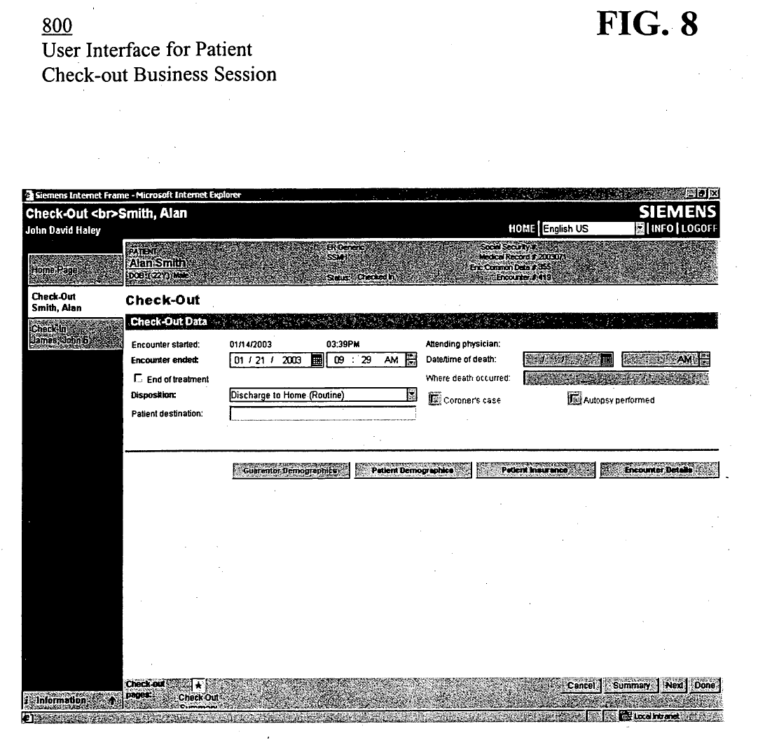

Preferably, browser software 113 cooperates with the user interface 114 by permitting information to be entered into the browser software 113 and by permitting information to be displayed by the browser software 113, as shown in FIGS. 7 and 8. Each of the switch 102 and the server(s) 103 may also have a user interface having an input device and an output device, which operates in the same or different way than the user interface 114 of the client device 22.

The processor 106, the memory 108, and the communication interface 110 are each well known to those skilled in the art of client systems. The memory 108 stores the software 112. The communication interface 110 is adapted to send and/or receive wired or wireless communications over the first communication path 104.

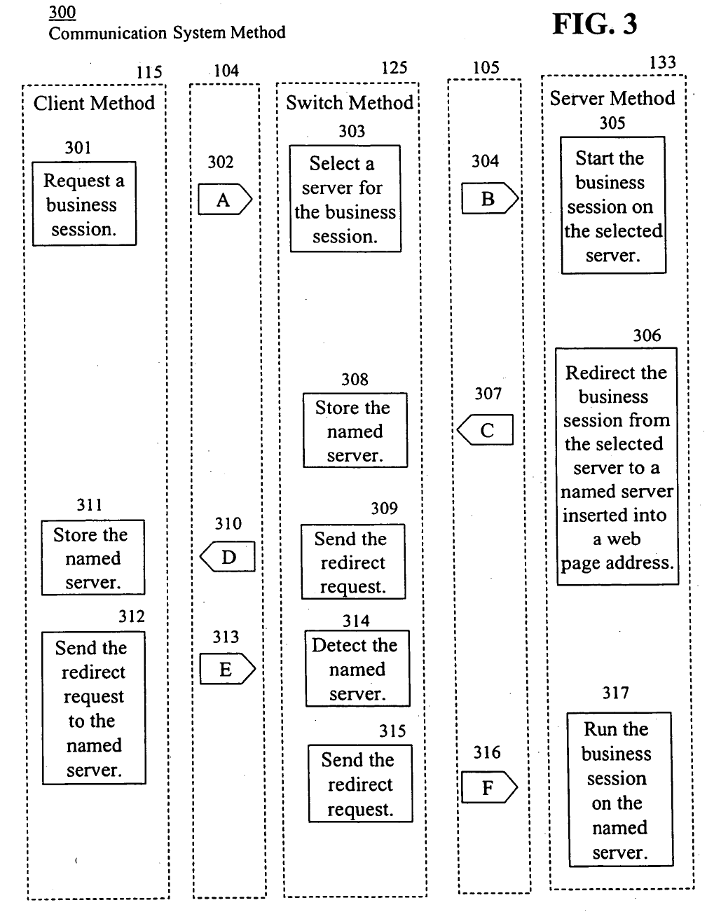

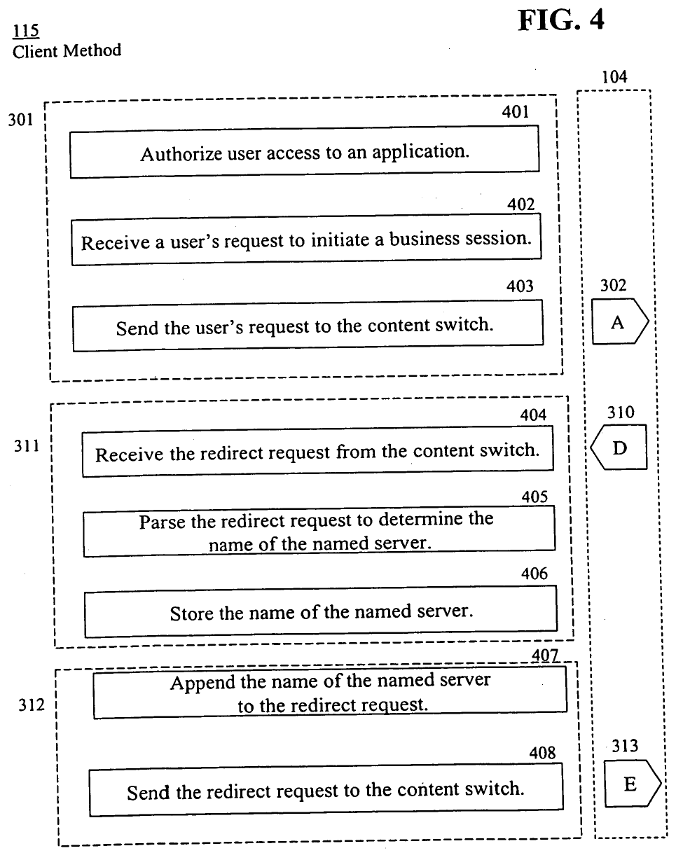

The software 112, including the browser software 113 and the client method 115, are of particular interest in the present application. The browser software 113 in cooperation with the user interface is described in further detail in FIGS. 7 and 8. The client method 115 is described in further detail in FIGS. 3 and 4.

The switch 102 further includes a processor 116, a memory 118, a communication interface 120, and software 122. The switch 102 connects one or more clients 101 to one or more servers 103 via the first communication network 104 and via the second communication network 105. A user interface, with browser software if desired, (each not shown) may also be used with the switch 102, as described with the client 101, if required or desired. The software 122 further includes content rules 123 and a switch method 125. Each of the referenced elements, as well as other known elements not shown, in the switch 102 are interconnected in a manner well known to those skilled in the art of switches.

The processor 116, the memory 118, and the communication interface 120 are each well known to those skilled in the art of content switches. The memory 118 stores the software 122. The communication interface 120 is adapted to send and/or receive wired or wireless communications over the first communication path 104 and over the second communication path 105.

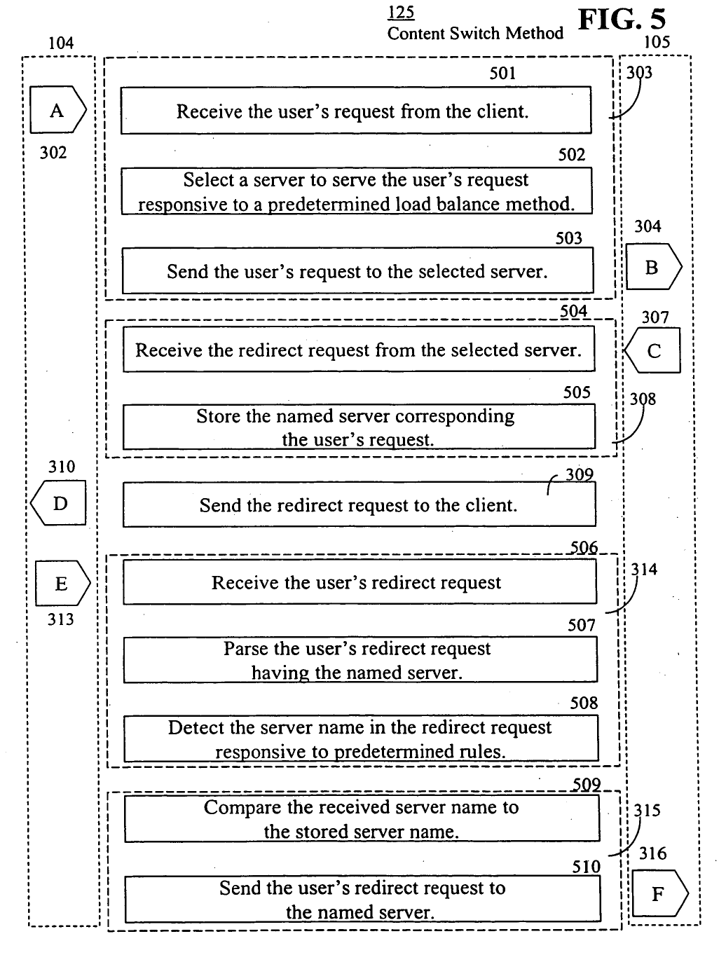

The software 112, including the content rules 123 and the switch method 125, are of particular interest. The content rules 123 and the switch method 125 are described in further detail in FIGS. 3 and 5.

Each of the server(s) 103 further includes a processor 124, a memory 126, a communication interface 128, and software 130. Preferably, the server 103 is implemented as a personal computer, a workstation, or other networked processing device. A user interface, with browser software if desired, (each not shown) may also be used with one or more of the server(s) 103, as described with the client 101, if required or desired. The software 130 further includes a management application 131 and a server method 133. Each of the referenced elements, as well as other known elements not shown, in the server(s) 103 are interconnected in a manner well known to those skilled in the art of servers.

Preferably, the server(s) 103 operate as identical copies of each other and are able to handle the requests received from the second communication network 105. Preferably, tasks are distributed equally among the individual servers 103 to balance the overall loading of the servers 103 in order to obtain optimum performance. To achieve this, it is necessary to direct the individual requests arriving from the first communication network 104 to the individual servers 103.

The processor 124, the memory 126, and the communication interface 128 are each well known to those skilled in the art of servers. The memory 126 stores the software 130. The communication interface 128 is adapted to send and/or receive wired or wireless communications over the second communication path 105.

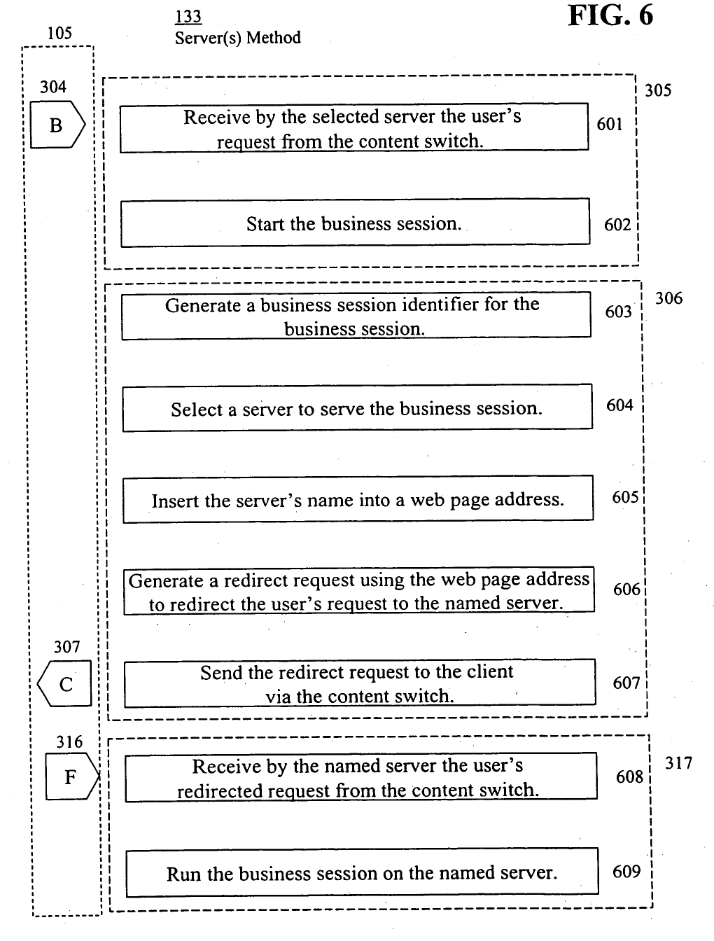

The software 130, including the management application 131 and the server method 133, are of particular interest in the present application. The management application 131 and the server method 133 are described in further detail in FIGS. 3 and 6.

The first communication path 104 provides communications between the client 101 and the switch 102. The second communication path 105 provides communications between the switch 102 and the server(s) 103. The term “path” may otherwise be called a network, a link, a channel, or a connection. The first communication path 104 and the second communication path 105 may be the same path or different paths, depending on the particular system.

The communication path 104 may be formed as a wired or wireless (W/WL) connection. A wireless connection advantageously permits the client 101 to be mobile beyond the distance permitted by the wired connection. Preferably, the communication path 104 is formed as a wired connection. In the case of a wired connection, the IP address is preferably assigned to a physical location of the termination point of the wire, otherwise called a jack. The jack is mounted in a fixed location relative to the client 101. In the case of a wireless connection, the IP address is preferably assigned to the client 101, since the client 101 would be mobile. The communication path 105 also may be formed as a wired or wireless (W/WL) connection.

Each of the paths 104 and 105 may be formed as any type of network including, without limitation, a Local Area Network (LAN), such as an Intranet, for example, and a Wide Area Network (WAN), such as an Internet, for example. Preferably, the first communication path 104 is formed as the WAN, such as the Internet, and the second communication path 105 is formed as a LAN, such as the Intranet.

The Internet is a decentralized network of computers that communicate with one another via the TCPIP. The explosive growth in use of the Internet is due in part to the development in the early 1990's of the worldwide web (WWW), which is one of several services provided on the Internet. Other services include, without limitation, communication services such as Email, telnet, newsgroups, internet relay chat (IRC), instant messaging, information search services such as Google™ and AltaVista™, and information retrieval services such as File Transfer Protocol (FTP).

The WWW is a client-server based service that includes a number of servers 103 (computers connected to the Internet) on which web pages or files reside, as well as clients 101 having web browsers 113, which provide a user interface for the users to the web pages. The web browser 113, such as Explorer™ (MicroSoft Corp.) or Navigator™ (Netscape Communication Corp.), send a request over the WWW to a server requesting a web page identified by a uniform resource locator (URL), which notes both the server where the web page resides and the file or files on that server 103 which make up the web page. The server 103 then sends a copy of the requested file(s) to the web browser 113, which in turn displays the web page to the user. The web pages on the WWW may be hyper-media documents written in a standardized language called Hyper Text Markup Language (HTML). A typical web page includes text together with embedded formatting commands, referred to as tags, which can be used to control font size, font style and the like. The web browser 113 parses the HTML script in order to display the text in accordance with the specified format.

Each of the communication paths 104 and 105 may use any type of protocol, otherwise called data format, including, without limitation, an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, an Institute Of Electrical And Electronic Engineers (IEEE) bus compatible protocol, and an Health Level Seven (HL7) protocol.

Each of the paths 104 and 105 may use any type of address scheme including, without limitation, an address corresponding to a type of protocol described above, and a Universal Resource Locator (URL), otherwise called a web page address.

Each of the paths 104 and 105 may communicate any type of data for any type of application including, without limitation, still pictures, streaming video, audio, telephone messages, computer programs, messages, instructions, and Emails.

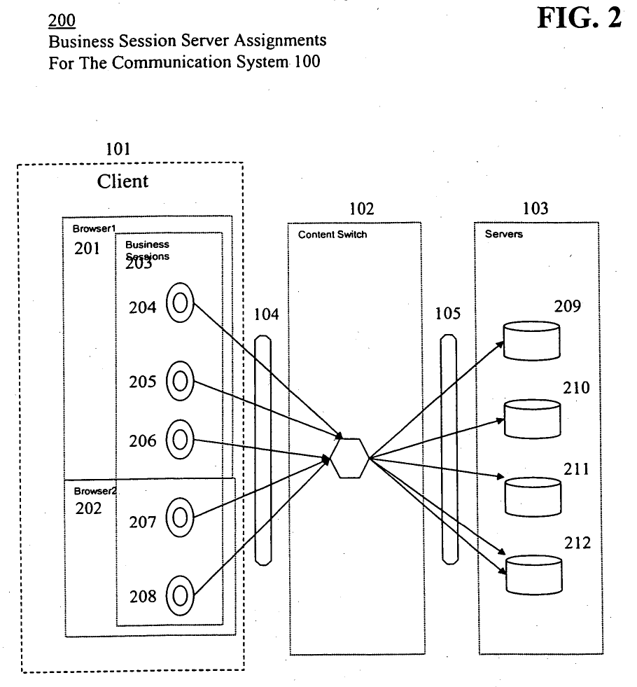

FIG. 2 illustrates business session server assignments for the communication system 100, as shown in FIG. 1, in accordance with the preferred embodiment of the present invention. The client 101 further includes a first browser 201, a second browser 202, and business sessions 203. The three business sessions 204-206 are opened using the first browser 201. The two business sessions 207 and 208 are opened using the second browser 202. The server(s) 103 further includes four servers 209-212.

In response to a user starting a business session, the content switch selects one server on which to execute this business session. When the same user starts another business session and does not terminate the previously started business session, a different server is assigned to execute this new business session depending on the load-balancing method used. For example, if the user executes four business sessions on the same browser and there are four servers in the server environment, each server may execute one business session. The operation of the server(s) 103 is transparent to users operating the business session(s). The communication system acts like one server supports the user's software application, but with improved performance for the reasons described herein.

FIG. 3 illustrates a communication system method 300 for the communication system 100, as shown in FIG. 1, in accordance with a preferred embodiment of the present invention. The communication system method 300 generally includes the client method 115, the switch method 125, the server method 133, the first communication network 104, and the second communication network 105. The client method 115 further includes steps 301, 311, and 312. The switch method 125 further includes steps 303, 308, 309, 314, and 315. The server method 133 further includes steps 305, 306, and 317. The first communication path 104 further includes communications 302, 310, and 313. The second communication path 105 further includes communications 304, 307, and 316.

Generally, the communication system method 300 follows consecutive steps and communications starting at step 301 through and ending with step 317. The consecutive steps and communications 301-317 generally form a backward “S” pattern across FIG. 3. The communication system method 300 starts at step 301 of the client method 115 by sending a communication 302 over the first communication path 104 to step 303 of the switch method 125, which, in turn, sends a communication 304 over the second communication path 105 to step 305 of the server method 133. Following the step 305 of the server method 133, step 306 sends a communication 307 over the second communication path 105 to step 308 of the switch method 125. Following step 308 of the switch method 125, step 309 sends a communication 310 over the first communication path 104 to step 311 of the client method 311. Following step 311 of the client method 311, step 312 of the client method sends a communication 313 over the first communication path 104 to step 314 of the switch method 125. Following step 314 of the switch method 125, step 315 sends a communication 316 over the second communication path 105 to step 317 of the server method 133.

More particularly, the communication system method 300 starts at step 301 of the client method 115, wherein the client method 115 requests a business session. The request for the business session is represented as communication 302, which is sent over the first communication path 104 to step 303 of the switch method 125. Step 303 of the switch method 125 selects a server for the requested business session. A request for the selected server is represented as communication 304, which is sent over the second communication path 105 to the server method 133. Step 305 of the server method 133 starts the business session on the selected server. Following step 305 of the server method 133, step 306 of the server method 133 redirects the business session from the selected server to a named server inserted into a web page address. A request for redirect to the named server is represented as communication 307, which is sent over the second communication network 105 to step 308 of the switch method 125. Step 308 of the switch method 125 stores the named server in the switch 102. Following step 308 of the switch method 125, step 309 of the switch method 125 sends the request for redirect over the first communication path 104 to step 311 of the client method 115. Following step 311 of the client method 115, step 312 of the client method 115 sends the redirect request to the named server. A request for a redirect request to the named server is represented as communication 313, which is sent over the first communication path 104 to step 314 of the switch method 125. Step 314 of the switch method 125 detects the named server. Following step 314 of the switch method 125, step 315 sends the redirect request to the named server. A request for the redirect request to the named server is represented by communication 316, which is sent over the second communication path 105 to step 317 of the server method 133. Step 317 of the server method 133 runs the business session on the named server.

Generally, the system 100 advantageously solves a problem, involved in sticking a business session to a server, related to letting the first request from the business session and its subsequent requests be assigned to the same server. The system 100 addresses this problem and associated problems by providing the following features. The server 103 reports to the client 101 for which the server served the first request of the business session. The client 101 remembers which server served the first request during the whole business session. The client 101 notifies the content switch 102 which server it wants for a given business session. The system 100 advantageously distributes each business session to any server of the operating environment, and then executes on that server to ensure that the session executes correctly.

Preferably, the system 100 advantageously provides these features using an hypertext transfer protocol (HTTP) redirect verb, hypertext markup language (HTML) bookmarks, a client-based program (e.g., Applet and/or JavaScript), and predetermined content switch configuration rules. However, in other embodiments other mechanisms may alternatively be used. With the HTTP redirect and HTML bookmarks, a server 103 reports to the client which server has served the first request. With the Java Applet as a client-side program, a client 101 is able to remember which server the business session should be sticky to. The content switch 102 rules enable the client 101 to instruct the content switch as to which server the business session should be served.

In particular, the system 100 uses the HTTP redirect verb, the URL bookmark, and a specific content switch load-balancing strategy. The HTTP redirect verb redirects a HTTP request from the original receiving server to a different server. The URL bookmark is a character string that is appended to a web address to instruct a web browser which location of the web page to display. The content switch's load-balancing strategy is a set of content switch configurations, such as content rule definitions, service definitions, etc., which are defined to enable the content switch 102 to achieve certain behaviors.

Preferably, the system 100 achieves the load balancing at the business session level, wherein the HTTP requests from the same business session of a user (i.e., users that operate on saved state on the server) are assigned to the same server. Since some applications allow one user to run multiple business sessions on a single browser, the stickiness at this level advantageously supports the balance of a single users' load on the different servers.

The system 100 also provides an additional benefit of enabling servers to be drained for maintenance while minimizing interruptions of the users who are currently using the web applications. Thus, users do not experience any interruption when different servers have been used to serve their business sessions.

Next, FIGS. 4, 5 and 6 are grouped together to describe the consecutive steps and communications starting at step 301 through and ending with step 317 in the same general backward “S” pattern described in FIG. 3, because the general backward “S” pattern extends across FIGS. 4, 5 and 6. Hence, the following description of FIGS. 4, 5 and 6 jumps from one figure to the next figure in the general backward “S” pattern. For convenience and ease of understanding, FIGS. 4, 5 and 6 may be consecutively laid out next to each other, wherein FIG. 4 is on the left side of FIG. 5, FIG. 5 is between FIGS. 4 and 6, and FIG. 6 is on the right side of FIG. 5.

FIG. 4 illustrates a detailed client method 115 for the communication system method 300, as shown in FIG. 3, in accordance with the preferred embodiment of the present invention. The detailed client method 115 generally includes steps 301, 311, and 312, each step being represented by dashed boxes. Step 301 further includes three consecutive steps 401-403. Step 311 further includes three consecutive steps 404-406. Step 312 further includes two consecutive steps 407 and 408.

FIG. 5 illustrates a detailed content switch method 125 for the communication system method 300, as shown in FIG. 3, in accordance with the preferred embodiment of the present invention. The detailed content switch method 125 generally includes steps 303, 308, 309, 314, and 315, each step being represented by dashed boxes. Step 303 further includes three consecutive steps 501-503. Step 308 further includes two consecutive steps 504 and 505. Step 309 further includes one step, as itself. Step 314 further includes three consecutive steps 506-508. Step 315 further includes two consecutive steps 509 and 510.

FIG. 6 illustrates a detailed server(s) method 133 for the communication system method 300, as shown in FIG. 3, in accordance with the preferred embodiment of the present invention. The detailed server(s) method 133 generally includes steps 305, 306, and 317, each step being represented by dashed boxes. Step 305 further includes two consecutive steps 601 and 602. Step 306 further includes five consecutive steps 603-607. Step 317 further includes two consecutive steps 608 and 609.

Beginning with FIG. 4, at step 401, the client 101 authorizes user access to an application. Preferably, this step is implemented by the processor 106, acting as an entitlement processor, authorizes user access to an application in response to validation of user identification information.

At step 402, the client 101 receives a user's request to initiate a business session 203 (shown in FIG. 2) responsive to step 401.

At step 403, the client 101 sends the user's request, represented as communication 302, over the communication path 104 to the switch 102 responsive to step 402.

Continuing to FIG. 5, at step 501, the switch 102 receives the user's request, represented as communication 302, over the communication path 104 from the client 101 responsive to the step 403.

At step 502, the switch 102 selects a server to serve the user's request using a predetermined load balancing method responsive to the step 501.

At step 503, the switch 102 sends the user's request, represented as communication 304, over the communication path 105 to the selected server 103 responsive to the step 502.

Continuing to FIG. 6, at step 601, the selected server 103 receives the user's request, represented as communication 304, over the communication path 105 from the switch 102 responsive to step 503.

At step 602, the selected server 103 starts a business session 203 on the selected server 103 responsive to step 601.

At step 603, the selected server 103 generates a business session identifier for the business session 203 responsive to step 602.

At step 604, the selected server 103 selects (i.e., names) a server to serve the business session 203 responsive to step 603.

At step 605, the selected server 103 inserts the server's name into a web page address responsive to step 604.

At step 606, the selected server 103 generates a redirect request using the web page address to redirect the user's request, represented by communication 304, to the named server responsive to step 605.

At step 607, the selected server 103 sends the redirect request, represented as communication 307, over the communication path 105 to the switch 102 responsive to step 607.

Returning to FIG. 5, at step 504, the switch 102 receives the redirect request, represented as communication 307, over the communication path 105 from the selected server 103 responsive to step 607.

At step 505, the switch 102 stores the named server corresponding to the user's request, represented as communication 307, responsive to step 504.

Continuing with FIG. 5, at step 309, the switch 102 sends the redirect request, represented as communication 310, over the communication path 104 to the client 101 responsive to step 505.

Returning to FIG. 4, at step 404, the client 101 receives the redirect request, represented as communication 310, over the communication path 104 from the switch 102 responsive to step 309.

At step 405, the client 101 parses the redirect request, represented as communication 310, to determine the name of the named server responsive to step 404.

At step 406, the client 101 stores the name of the named server responsive to step 405.

At step 407, the client 101 appends the name of the named server to the redirect request responsive to step 406.

At step 408, the client 101 sends the redirect request, represented as communication 313 and having the named server, over the communication path 104 to the switch 102 responsive to step 407.

Continuing back to FIG. 5, at step 506, the switch 102 receives the user's redirect request, represented as communication 313 and having the named server, over the communication path 104 from the client 102 responsive to step 408.

At step 507, the switch 102 the switch 102 parses the redirect request, represented as communication 313 and having the named server, responsive to step 506.

At step 508, the switch 102 the switch 102 detects the name of the named server in the redirect request, represented as communication 313, using predetermined rules responsive to step 507.

At step 509, the switch 102 compares the received named server to the stored named server responsive to step 508.

At step 510, the switch 102 sends (i.e., redirects) the user's redirect request, represented as communication 316, over the communication path 104 to the named server responsive to step 509.

Continuing back to FIG. 6, at step 608, the named server receives the user's redirect request, represented as communication 316, over the communication path 104 from the switch 102 responsive to step 510.

At step 609, the named server runs the business session 203 responsive to step 608. When a business session starts, the client 101 sends a HTTP request to the server-side application. The content switch 102 uses the pre-selected load-balancing method to choose a server to serve the request. When the server-side application receives the request, it starts a business session on the server and generates the data context for the business session. Then, the server-side application places the server name as a bookmark into the HTML form URL to which the client 101 is re-directed. The script in the HTML form then parses the URL, gets the server name, and stores it. When the client sends subsequent HTTP requests to execute the business session, the server name will be appended as a parameter to the URL. The content switch 102, which has been configured accordingly, detects the server name and sends the HTTP request to the corresponding server for processing.

The system 100 embodiment implements the method 300 using the following software and hardware, for example. JavaScript ® software parses the URL bookmark redirected from server side and saves the server name. Microsoft ® Active Server Page (ASP) software takes the initial request from a client, starts a business session at server side and then redirects the request to a URL that refers to a HTML form that is associated with the business session. The URL contains the server name as a bookmark.

A content switch available from Cisco ® called IP-Director ® is also employed, but alternative rule based switches may also be used. The IP-Director detects URLs in the HTTP traffic to execute predetermined sticky content rules to assign the requests to servers. The IP-Director is advantageously configured to incorporate content rules including the rules described below, for example.

A content rule defines for what URL the rule is to be applied and what character string inside the URL the rule should search for to achieve the server stickiness. An exemplary sticky rule is provided as follows.

content Rule_Name

add service server_1

add service server_2

advanced-balance url

string prefix “ServerName=”

string eos-char “&”

vip address 10.2.0.300

no persistent

url “//siteURL/sitePath/*”

active

The above rule defines that the load balancing is between two servers: server_1 and server_2. The rule uses an advanced-balance URL that detects the string between “ServerName=” and “&.” If this string matches some server identifier, the corresponding server processes the request. Preferably, the rule is applied when the HTTP request satisfies the pattern “//siteURL/sitePath/*”.

The service configuration includes the following definition.

server_1

String server_1

server_2

String server_2

The service configuration above defines the server server_1 has identifier server_1 and the server server_2 has identifier server_2.

Thus, a URL such as, for example: “http://siteURL/sitePath/Request.asp?ServerName=server_1& . . . ” triggers an application of the content rule and initiates sending the request to server_1 for processing.

To take advantage of the persistent HTTP connection offered in HTTP 1.1, the HTTP requests are divided to the servers depending on if they are stateful (contains ServerName=<server name here>) or stateless (e.g. .gif, .js and .html files). The system 100 uses the persistent connection for stateless requests and uses the non-persistent HTTP connection for stateful requests. The persistent connection overcomes the overhead in re-connecting to the web servers.

FIG. 7 illustrates a user interface for a patient check-in business session 700 for the client 101, as shown in FIGS. 1 and 2, and for the detailed client method, as shown in FIG. 4, in accordance with the preferred embodiment of the present invention. For example, when a user runs a check-in business session for patient “John G. James,” FIG. 7 appears to the user.

FIG. 8 illustrates a user interface for a patient check-out business session 800 for the client, as shown in FIGS. 1 and 2, and for the detailed client method, as shown in FIG. 4, in accordance with the preferred embodiment of the present invention. For example, when a user runs a check-in business session for patient “Alan Smith,” FIG. 8 appears to the user. Although FIGS. 7 and 8 describe patient check-in and check-out business sessions, any other type of business session may be used by a user. Such alternative business sessions include healthcare and non-healthcare related business sessions.

Balancing the server load based upon the business sessions involves distributing the business sessions running on a single web browser to different servers, and assigning each business session to a single server to enable the session to execute with the required state data (i.e., often referred as “stickiness” in the technical field). The system 100 enables servers to be drained for maintenance, which minimizes the interruptions on the users who are currently using the web applications. Thus, users do not experience any interruption when different servers have been used to serve their business sessions. The system 100 does not require the replication of the data for the business sessions on the servers. Replication causes more system resources (e.g., hard disk space) to be available and minimizes system administrative support. The business-session-based load balancing provides finer resolution load-balancing and better performance in situations when users have uneven workloads on the servers. The system 100 provides better response time, consistency performance when some users run many business sessions while some other users run significantly fewer business sessions. By contrast, prior systems assign the users that are running fewer business sessions to a server, while assigning users that are running many business sessions to a different server, which can cause uneven load within a server farm.

Thus, users advantageously use single browser to run multiple stateful business sessions concurrently. The system 100 does not require the application servers to maintain a copy of the same application state and avoids the complexity and the burden of the data replication among the servers. The system 100 further enables the gradual clearing of business sessions off the servers that need to be suspended for maintenance and provides load-balancing more evenly, when users run significantly different number of business sessions, for example. The system 100 is applicable to any web applications that run multiple business sessions on a single browser including, for example, on-line shopping websites, on-line trading systems, and other information systems that are based upon web technologies. The system 100 also supports server load-balancing based upon the business sessions. The server load-balancing is at a lower technical level compared with that of the other load-balancing strategies. Therefore, the server load-balancing provides a more even (i.e., finer grain) load-balancing.

Existing web application architecture and configuration of the content switch 102 may be readily modified to incorporate the system 100. Modifications may include changing existing web application architecture and configuration of content switch(es). For example, an on-line shopping website benefits from support of multiple shopping carts on a single browser and load-balanced servers supporting the shopping carts. The system 100 also provides better user response time consistency since the system 100 ensures the load be more evenly distributed among the servers. The system 100 also enables server administrators to tune and optimize the system performance based upon the business session types (e.g., patient check-in, patient check-out, quick check-in).

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A system employed by a first application for supporting concurrent operation of a plurality of user initiated operation sessions, comprising:
a communication processor for communicating a session initiation request to a managing application to initiate generation of a session identifier particular to a user initiated session and for receiving from said managing application data representing a response address link identifying an address of a web page supporting said particular user initiated session, said data representing said response address link incorporating an identifier for identifying a particular server supporting said particular user initiated session; and
a processor for parsing said received data representing said response address link to extract and store said server identifier for use in directing communications associated with said particular user initiated session to said particular server.

2. A system according to claim 1, wherein
said communication processor initiates communication associated with said particular user initiated session with said particular server using a URL incorporating data representing said particular server identifier.

3. A system according to claim 2, including
a switch for receiving and parsing said URL to detect said data representing said particular server identifier and for redirecting said communication associated with said particular user initiated session to said particular server.

4. A system according to claim 3, wherein
said switch detects said data representing said particular server identifier in response to predetermined rules and
said predetermined rules compare URL character strings with a predetermined character string to determine a match of a server identifier with stored predetermined server identifiers to identify a particular server.

5. A system according to claim 1, wherein
said processor for parsing said received response address link is implemented in at least one of, (a) JavaScript, (b) XML, (c) HTML, (d) another Script language and (e) another computer language.

6. A system according to claim 1, wherein
said session identifier is used to uniquely identify said user initiated session.

7. A system according to claim 1, wherein
said session initiation request to said managing application also initiates generation of an encryption key particular to said user initiated session for use by said first application.

8. A system according to claim 1, including
an entitlement processor for authorizing user access to said first application in response to validation of user identification information.

9. A system according to claim 1, wherein
said managing application manages operation of a server.

10. A system according to claim 1, wherein
said communication processor communicates said session initiation request to said managing application using a URL.

11. A system employed by a managing application for supporting concurrent operation of a plurality of user initiated application operation sessions, comprising:
a session identifier generator for generating a session identifier particular to a user initiated session in response to a received session initiation request; and
an interface processor for providing data representing a response address link identifying an address of a web page supporting said particular user initiated session, said response address link incorporating an identifier for identifying a particular server supporting said particular user initiated session.

12. A system according to claim 11, wherein
in response to receiving a URL address associated with said session initiation request,
said interface processor provides a redirected URL as said response address link comprising a redirected URL identifying an address of said web page supporting said particular user initiated session and incorporating an identifier for identifying a particular server supporting said particular user initiated session.

13. A system according to claim 11, including
a switch for receiving and parsing a URL to detect said data representing said particular server identifier and for redirecting said communication associated with said particular user initiated session to said particular server.

14. A system according to claim 13, wherein
said switch detects said data representing said particular server identifier in response to predetermined rules and
said predetermined rules compare URL character strings with a predetermined character string to determine a match of a server identifier with stored predetermined server identifiers to identify a particular server.

15. A system according to claim 11, wherein
said system is implemented in at least one of, (a) Microsoft Active Server Page (ASP) compatible language and (b) another computer language.

16. A network compatible system for distributing messages associated with a plurality of user initiated operation sessions of an executable application, comprising:
an interface processor for receiving data representing a URL associated with a request for data supporting a particular user initiated session; and
a switch processor for,
parsing said data representing said URL to identify data representing a server identifier,
comparing said server identifier with a plurality of stored predetermined server identifiers to identify a matching server identifier corresponding to a particular server and for redirecting said request for data supporting said particular user initiated session to said particular server in response to a match.

17. A system according to claim 16, wherein
said switch processor compares said server identifier with said plurality of stored predetermined server identifiers by comparing a character string of said server identifier with character strings of said plurality of stored predetermined server identifiers.

18. A network compatible system for distributing messages associated with a plurality of user initiated operation sessions of an executable application, comprising:
an interface processor for receiving data representing a URL associated with a request for data supporting a particular user initiated session; and
a switch processor for,
parsing said data representing said URL to identify whether said URL is associated with a data request of a first or different second type, and
processing said URL associated data request of a first type differently to a URL associated data request of a second type.

19. A system according to claim 18, wherein
said switch processor parses said data representing said URL to identify whether said URL associated data request is of a first type by determining if a URL data field identifies a server.

20. A system according to claim 19, wherein
said switch processor parses said data representing said URL to identify whether said URL associated data request is of a first type by determining if said URL data field contains an ASP extension.

21. A system according to claim 18, wherein
said switch processor parses said data representing said URL to identify whether said URL is stateless.

22. A system according to claim 21, wherein
said switch processor determines if said URL data field is stateless if it contains at least one of, (a) a .gif extension, (b) a .js extension (c) a .jpeg extension and (d) a .html extension.

23. A system according to claim 18, wherein
a URL associated data request of a first type is performable by a particular server and
a URL associated data request of a second type is performable by a plurality of different servers.

24. A system according to claim 23, wherein
if said URL is associated with a data request of a first type,
said switch processor compares said server identifier with a plurality of stored predetermined server identifiers to identify a matching server identifier corresponding to a particular server and for redirecting said request for data supporting said particular user initiated session to said particular server in response to a match.

25. A system according to claim 23, wherein
if said URL is associated with a data request of a second type,
said switch processor directs said request for data supporting said particular user initiated session to any one of said plurality of different servers.
